(19) United States
(12) Patent Application Publication
(10) Pub. No.: US 2007/0087213 A1
(43) Pub. Date: Apr. 19, 2007

(54) METHOD FOR TREATING WOOD

(76) Inventors: Philip Leslie Robinson, Isle of Palms, SC (US); Jane Elizabeth Blasser, Mount Pleasant, SC (US); Michael Alan Lake SR., Mount Pleasant, SC (US); G. Frederick Hutter, Charleston, SC (US); Frederick Eugene Bishop JR., Charleston, SC (US); David Lawrence Smith, Charleston, SC (US)

Correspondence Address: MEADWESTVACO CORPORATION, Division and Technical Center - Law Dept., PO BOX 118005, CHARLESTON, SC, 29423-8005, US

(21) Appl. No.: 11/566,285

(22) Filed: Dec. 4, 2006

Related U.S. Application Data
(63) Continuation-in-part of application No. 10/998,776, filed on Nov. 29, 2004.
(60) Provisional application No. 60/546,293, filed on Feb. 20, 2004.

(51) Int. Cl. B27K 3/15

(52) U.S. Cl. 428/541

(57) ABSTRACT

The present invention relates to a process for treating wood and other cellulosic materials to render the resistance to wood attacking organisms, such as termite, fungi and insects. More particularly, the present invention relates to a process for treating wood with borate preservative formulation which contains at least one boron-containing component and at least one resinous component capable of retaining impregnated borate inside the treated wood even upon contact with water. The resinous component may be rosin, rosin derivative, tall oil-based compound, or mixtures thereof.

This is a continuation-in-part application of co-pending and commonly assigned U.S. application Ser. No. 10/998,776 filed on Nov. 29, 2004, which is a non-provisional application relies on the filing date of provisional Application Ser. No. 60/546,293, filed on Feb. 20, 2004.

### FIELD OF INVENTION

The present invention relates to a process for treating wood and other cellulosic materials to render the resistance to wood attacking organisms, such as termite, fungi and insects. More particularly, the present invention relates to a process for impregnating wood and other cellulosic materials with a borate preservative, in such a manner that the borate wood preservative is leach-resistant when the wood is in contact with water, thereby allowing its use for exterior applications.

### BACKGROUND OF THE INVENTION

Copper chrome arsenate (CCA), a leach-resistant wood preservative known for exterior application, was recently banned because of the toxic nature of arsenic and chromium. Since then, there has been a continuing effort to develop suitable alternative systems. A number of alternative, non-arsenical pesticidal treatments containing heavy metals (primarily copper) have been proposed. For example, U.S. Pat. No. 4,929,454 teaches the treatment of wood with a mixture of a copper compound and a quaternary ammonium compound. This technology has been commercialized under the name ammoniated copper quaternary amine (ACQ). It has excellent insect resistance, but it is considerable more costly than CCA, and it has a tendency to promote the growth of white mold on the wood surface. Furthermore, ACQ-treated wood may exhibit corrosion problems with most metal fasteners when the treated wood is placed into service. Special fasteners having high corrosive resistance are required for the ACQ treated wood, causing an additional cost of using ACQ-treated wood for construction. Furthermore, there has been increasing concerns on the toxicity and environmental impact of wood preservatives containing heavy metals.

Borate has been used as wood preservative for more than 50 years, since it is effective against most wood destroying organisms such as fungi, termite and wood-boring beetles. Furthermore, borate has a low acute mammalian toxicity and low environmental impact. Borate has been considered as an excellent candidate for the CCA replacement for wood preservative application. However, the well-known disadvantage of borate wood preservative is that borate is readily soluble in water, and easily leaches out of the treated wood upon contact with water. As a result, the use of borate preservative is limited to the treated wood for interior applications.

Several methods have been used to prevent the leaching of impregnated borate preservatives from the treated wood. U.S. Pat. No. 2,194,827 uses solubilized metals such as zinc and copper to fix borate in wood. This method requires high concentrations of ammonia to solubilize such metals and borates, resulting in excessive ammonia volatility and noxious fumes that are undesirable for large scale preparation. U.S. Pat. No. 6,896,908 addresses the ammonia off-gas issue by dissolving a high concentration of copper and/or zinc metal fixative agent in an aqueous solution of ammonia, volatile organic acid and ammonium salts. The combination of a volatile organic acid and ammonia provides a high rate of metal dissolution without requiring excessive levels of ammonia in solution, and the ammonium salt reduces the level of free ammonia needed for dissolution of metals. U.S. Pat. No. 5,207,823 discloses copper borate and/or zinc borate in combination of amine as a leach-resistant borate wood preservative. PCT Patent No. 95/27,600 teaches the use of nitrite to improve fixation of preservatives in wood, when the preservatives contains one or more copper and/or zinc salts of weak acid, and optionally boric acid and quaternary ammonium salt. U.S. Pat. No. 6,146,766 discloses the use of water soluble sodium silicate/borax mixture wherein the impregnated silicate component can be polymerized to reduce its water-solubility, thereby decreasing the leaching rate of water-soluble preservative from the treated wood. U.S. Pat. No. 6,508,869 uses amine oxide to improve leaching resistance of boron preservatives from the treated wood. In U.S. Pat. No. 5,087,457, polyammonium salts formed through the reaction of diamine and dihalide, are used in combination with borate to reduce leaching rate. However, the problem with these methods is that even the most water-insoluble borates, boric esters, and borate complexes will, on prolonged contact with water, hydrolyze to form boric acid which will leach out of the wood.

U.S. Pat. No. 4,276,329 discloses a method of enhancing the dimensional stability of wood by swelling and impregnating the cell walls of the wood with a solution of low molecular weight polymer in water and water-miscible solvent. It also teaches that additives such as borates can be carried into the cell walls along with the polymer. In this method, the water-miscible organic cosolvent is a disadvantage for environmental reasons. It would be desirable to have a resinous material that would fix the borate in the wood without the necessity of using such a solvent.

The present invention offers an alternative mechanism for fixing borate compounds in wood, that of making the wood so hydrophobic that water can not enter the wood in sufficient amount to leach out the borate. It is well known in the art that the surface of wood can be rendered hydrophobic by coating it with paints, varnishes, waxes, and similar materials. However, doing so can be labor-intensive and relatively costly. Applying a traditional hydrophobic coating at the wood mill, as is often done with railroad ties or telephone poles, is much less labor-intensive than painting or varnishing. However, lumber used in construction is usually cut, drilled, routed, and otherwise machined in the course of its use, which would tend to breach such traditional factory coatings, allowing water penetration.

It is an object of the present invention to provide a method for making wood resistant to damage caused by soil microbes and/or insects by treating the wood with a formulation containing at least one boron-containing compound and at least one hydrophobic compound chosen from rosin-based compound, tall oil-based compound, and mixtures thereof.

It is another object of the present invention to provide borate wood preservatives that not only enhance boron retention in the treated wood or other cellulosic materials, but also minimize toxicity and environmental impact. More particularly, it is an object of the present invention to provide a borate wood preservative containing no heavy metal, thereby eliminating the concerns on the toxicity and environmental impact of heavy metals such as chromium, zinc and copper.

It is yet another objective of the present invention to provide borate wood preservatives that use naturally-occurring materials to retain the impregnated boron inside the treated wood.

It is a further objective of the present invention to provide a process for treating wood or other cellulosic materials with borate preservatives having improved boron retention that can be readily done using the equipment and process commonly available and known for impregnation of typical wood preservatives such as CCA.

It is yet a further object of the present invention to provide treated wood with enhanced boron retention that can be used for exterior applications.

Other objects, features and advantages of the present invention will become apparent from the following detailed description.

### SUMMARY OF THE INVENTION

The objects of this invention are met by a process of treating wood with borate preservative formulation which contains at least one boron-containing component and at least one resinous component capable of retaining impregnated borate inside the treated wood even upon contact with water. The resinous component may be rosin, rosin derivative, tall oil-based compound, or mixtures thereof.

### BRIEF DESCRIPTION OF THE DRAWINGS

FIG. 1 is a graph showing the percentage of boron retention at different time intervals under the accelerated weathering conditions for the treated boards obtained from a two-step process, wherein the boards are treated first with boric acid and then resinous component.

FIG. 2 is a graph showing the percentage of boron retention at different time intervals under the accelerated weathering conditions for the treated boards obtained from a two-step process, wherein the boards are treated first with resinous component and then boric acid.

FIG. 3 is a graph showing the percentage of boron retention at different time intervals under the accelerated weathering conditions for the treated boards obtained from a two-step process, wherein the boards are treated first with a liquid containing resinous and chelating components and then boric acid.

FIG. 4 is a graph showing the percentage of boron retention at different time intervals under the accelerated weathering conditions for the treated boards obtained from a one-step process.

### DESCRIPTION OF THE INVENTION

The following detailed description illustrates embodiments of the present invention; however, it is not intended to limit the scope of the appended claims in any manner. It is to be understood that changes and modifications may be made therein as will be apparent to those skilled in the art. Such variations are to be considered within the scope of the invention as defined in the claims.

The advantages and purposes of the invention will be set forth in part in the description which follows, and in part will be obvious from the description, or may be learned by practice of the invention.

The borate preservatives of the present invention offer several benefits. They contain no heavy metals such as zinc, copper or chromium; therefore, they are more environmental friendly than the currently available CCA alternatives. They readily penetrate into wood and retain in the treated wood for a prolong period of time even after exposure to rigorous leaching conditions such as those for exterior applications. They contain low level of ammonia, thus avoiding the corrosion of metals in contact with the treated woods such as metal fasteners. Furthermore, the invention borate preservatives do not leave unsightly residue on the surface of the treated wood, typically observed with other CCA alternative.

The term “wood” in the present invention refers to any wooden article including, but are not limited to, structural lumbers, decking, facia boards, exterior grade plywood, construction elements for outdoor furniture or playground equipment, fencing, and the like.

A method of preparing treated wood for the present invention comprises a step of treating wood with a borate preservative formulation, wherein the non-volatile content of the preservative formulation comprises:
(a) at least one boron-containing compound; and
(b) at least one resinous component comprising at least one member selected from the group consisting of rosin, rosin derivatives, tall oil-based compounds, and mixtures thereof.

In one embodiment, a method of preparing treated wood for the present invention comprises a step of treating wood with a borate preservative formulation, wherein the non-volatile content of the preservative formulation comprises:
(a) from about 10% to about 90% by weight of at least one boron-containing compound; and
(b) from about 10% to about 90% by weight of a resinous component comprising at least one member selected from the group consisting of rosin, rosin derivatives, and mixtures thereof.

In one embodiment of the present invention, a method of treating wood comprises a step of treating wood with a borate preservative formulation, wherein the non-volatile content of the preservative formulation comprises:
(a) from about 30% to about 70% by weight of at least one boron-containing compound; and
(b) from about 30% to about 70% by weight of a resinous component comprising at least one member selected from the group consisting of rosin, rosin derivatives, and mixtures thereof.

The boron-containing compounds suitable for use in the present invention include, but are not limited to, boric acid, borate salts, borate esters, and mixtures thereof.

The resinous component of the present invention comprises at least one member selected from the group consisting of rosin, rosin derivatives, tall oil-based compounds, and mixtures thereof.

Suitable rosins for use in the present invention include, but are not limited to, tall oil rosin, gum rosin, wood rosin, and mixtures thereof. Rosin derivatives suitable for use in the present invention include, but are not limited to, the following: hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and mixtures thereof.

Tall oil-based compounds suitable for use in the present invention include, but are not limited to, tall oil pitch; crude tall oil (CTO); tall oil fatty acids (TOFA); and TOFA derivatives such as esters, salts, dimer acids, trimer acids, triglycerides, amides, adducts of acrylic acids, adducts of unsaturated fatty acids, and mixtures thereof. Adducts of acrylic acids and unsaturated fatty acids such as WESTVACO DIACID® available from MeadWestvaco are also suitable for use in the present invention. Other similar non-TOFA-derived fatty acids and derivatives may also be used.

Where desired, one or more non-rosin containing resinous materials can be admixed with the rosins and/or rosin derivatives. Additive non-rosin containing resinous materials suitable for admixture with the rosins and/or rosin derivatives may be those that are hydrophobic and that have solubility parameters similar to those of rosin acids. Suitable examples include, but are not limited to, the following: fatty acids, dimer acids, trimer acids, triglycerides, terpenes, phenolic resins, hydrocarbon resins, phenolic-modified terpene resins, phenolic-modified hydrocarbon resins, tall oil pitch, adducts of acrylic acids, adducts of unsaturated fatty acids, adducts of acrylic acids and unsaturated fatty acids such as WESTVACO DIACID® available from MeadWestvaco, and mixtures thereof.

In one embodiment of the present invention, the aforementioned resinous component comprises:
(a) from about 20% to about 100% by weight of the resinous component of at least one member selected from the group consisting of rosins, rosin derivatives, and mixtures thereof, and
(b) up to about 80% by weight of the resinous component of at least one non-rosin containing resinous material.

The borate preservative formulations of the present invention may be emulsion, dispersion, or solution. Aqueous or other common solvents known in arts such as mineral oil or toluene may be used as liquid medium for the preservative formulation. The liquid containing the boron component can be either a solution obtained from dissolving boron components directly into an aqueous phase, or an emulsion obtained from homogenizing an aqueous phase and an oil phase with an emulsifier.

Where desired, the method of the present invention may be practiced at a neutral pH in the range of about 6.0 to about 10.0 to minimize potential corrosion problems with fasteners (such as nails, screws, and the like).

The impregnation of board with the invention borate may be done by any method known to one of ordinary skill in the art including, but are not limited to, pressure treating, vacuum impregnating, soaking, spraying, painting, brushing, washing, dipping, rubbing, mixing, blending, infusion and the like.

In some embodiments of the present invention, wood was immersed in the borate preservative formulation at an ambient temperature or elevated temperature.

In some embodiments, the impregnation was carried out at elevated pressures. “Loading” refers to the absorption of the impregnating borate preservative by the wood. Methods of treating wood with chromated copper arsenate solutions and similar pesticidal mixtures at elevated pressures are well known in the art. The same equipment (e.g., pressure vessels) employed in such currently-used pesticide treatment methods can be readily adapted to the treatment of wood with the borate preservative of the present invention. The upper limit of the applicable pressure depends on the respective crushing strength of the wood, as collapsing of the wood should be avoided. In one embodiment, the applied pressure is in the range of about 50 psi to about 200 psi. Where desired, a vacuum may be applied during the impregnation step to enhance the efficiency of the loading.

Wooden boards may be treated with the invention borate preservative using one-step process and two-step processes. In the two-step process, wood was treated with the first liquid formulation and allowed to dry prior to the application of the second liquid formulation.

After treating with the invention borate preservative formulation, the treated boards may be dried under ambient condition. Kiln drying or other heat treatment may also be used to help fix the preservative components in the wood.

The treated boards were then placed under an accelerated weathering conditions simulating rainfall volumes of 90 inches per day, using a 24 hour-cycle water spray consisting of 3 hours of water spray, 3 hours of drying, 3 hours of water spray and 15 hours of drying. The treated boards were subjected to these accelerated weathering conditions for 14 weeks which equaled to a total of 8,820 inches of rain for an entire period. The sample of treated board was taken each week for the measurement of boron content. The boards treated with either only boric acid or disodium octaborate tetrahydrate (DOT) were included in the accelerated weathering as a control condition along with the boards treated with the invention borate preservatives. An inductively coupled plasma (ICP) device was used to measure the content of boron in each board before the treatment, and after every week of accelerated weathering. The retention of boron as a percentage of the initial impregnated boron level was calculated, and compared to those of the control boards.

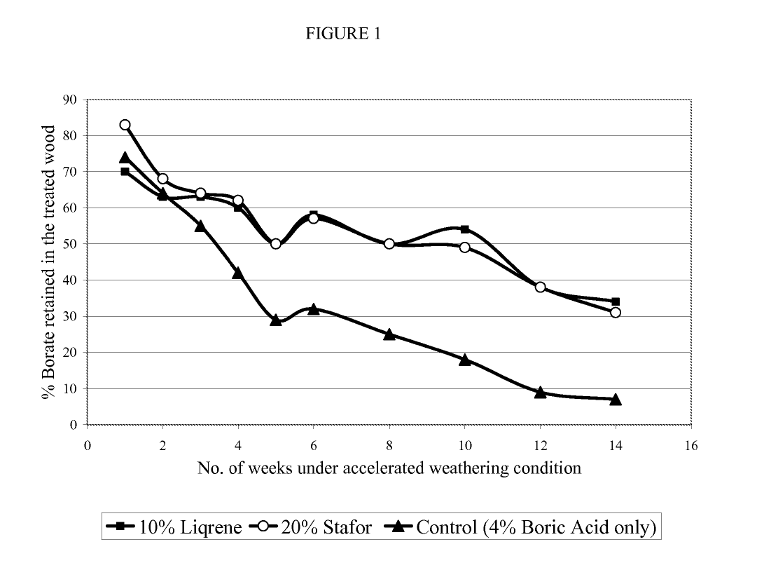

In one embodiment of the two-step process, wooden boards were first treated with an aqueous 4% boric acid solution. After one-week drying, the treated boards were secondarily treated with a liquid containing resinous component having about 10% to about 20% solid in toluene solvent. (Table 1, FIG. 1)

TABLE 1

| | | Amount of Boron in the Board | | |
|---|---|---|---|---|
| | | | 14-week | % Retention |
| 1^{st} Treating | 2^{nd} Treating | Initial | weathering | after 14-week |
| Formulation | Formulation | (ppm) | (ppm) | weathering |
| 4% Boric Acid | 10% Depitched | 3199 | 1088 | 34% |
| | CTO | | | |
| 4% Boric Acid | 20% Stafor ® | 2812 | 872 | 31% |
| | L-50 | | | |
| 4% Boric Acid | None | 3963 | 277 | 7% |

The control boards treated with only boric acid retained about 7% of the initial impregnated boron after 14 weeks of accelerated weathering test. Boards treated with boric acid and followed with depitched crude tall oil resin (CTO) retained about 34% of the initial boron content after 14 weeks of accelerated weathering test. Boards treated with boric acid and followed with Stafor® L-50, a potassium salt of fumarized rosin commercially available product from MeadWestvaco, retained about 31% of the initial boron content after 14 weeks of accelerated weathering test. Secondary treating of the boards, after the treatment with boric acid, showed a significant improvement in boron retention after severe weathering test.

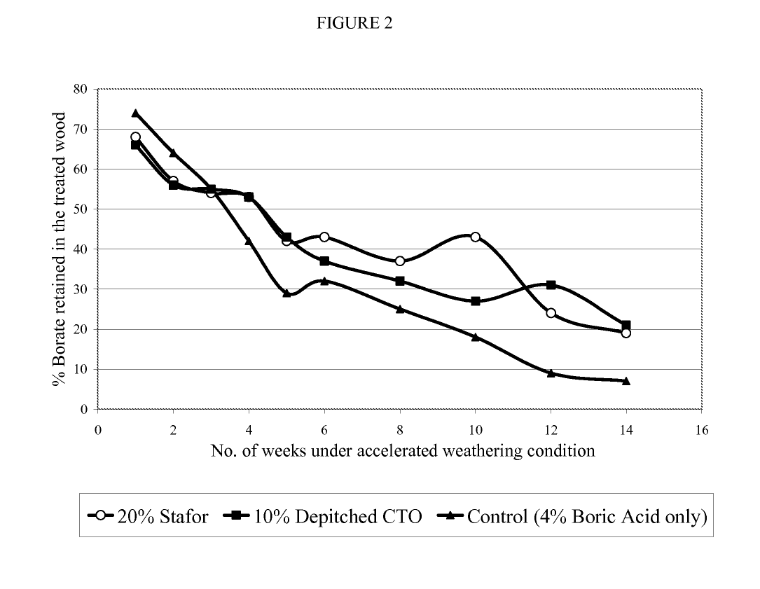

In one embodiment of the two-step process, wooden boards were first treated with a liquid containing resinous component. After one-week drying, the treated boards were secondarily treated with a 4% boric acid solution. (Table 2, FIG. 2)

TABLE 2

| | | Amount of Boron in the Board | | |
|---|---|---|---|---|
| | | | 14-week | % Retention |
| 1^{st} Treating | 2^{nd} Treating | Initial | weathering | after 14-week |
| Formulation | Formulation | (ppm) | (ppm) | weathering |
| 10% Depitched | 4% Boric Acid | 4465 | 938 | 21% |
| CTO | | | | |
| 20% Stafor ® | 4% Boric Acid | 2963 | 563 | 19% |
| L-50 | | | | |
| 4% Boric Acid | None | 3963 | 277 | 7% |

The control boards treated with only boric acid retained about 7% of the initial impregnated boron after 14 weeks of accelerated weathering test. Boards treated with depitched crude tall oil resin (CTO) followed with boric acid retained about 21 % of the initial boron content after 14 weeks of accelerated weathering testing. Boards treated with the potassium salt of fumarized rosin, Stafor® L-50, followed with boric acid, retained about 19% of the initial boron content after 14 weeks of accelerated weathering test.

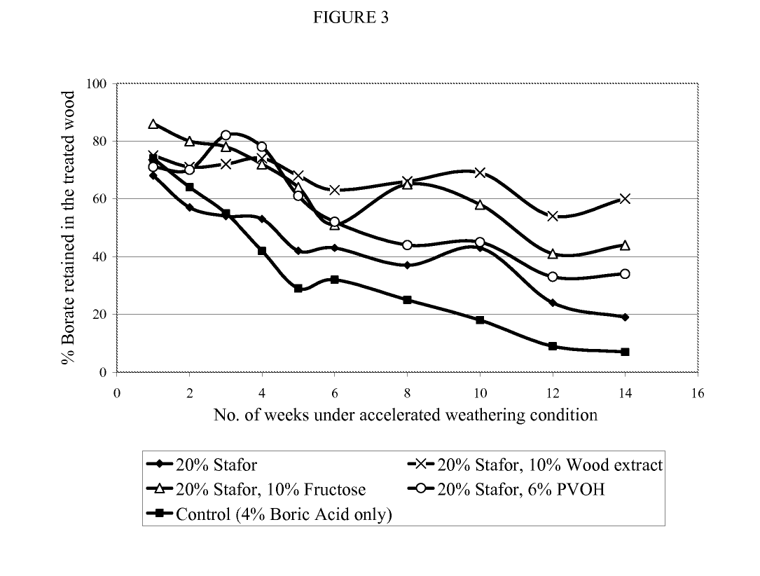

In some embodiments of the present invention, the preservative formulation further comprises at least one component capable of chelating with boron to additionally enhance the retention of borate preservative in the treated wood. Boards were first treated with a liquid formulation containing a resinous component and a chelating component. After one-week of drying, the treated boards were secondarily treated with a 4% boric acid solution. (Table 3, FIG. 3)

TABLE 3

| | | Amount of Boron in the Board | | |
|---|---|---|---|---|
| | | | 14-week | % Retention |
| 1^{st} Treating | 2^{nd} Treating | Initial | weathering | after 14-week |
| Formulation | Formulation | (ppm) | (ppm) | weathering |
| 20% Stafor ® | 4% Boric Acid | 2963 | 56 | 19% |
| L-50 | | | | |
| 20% Stafor ®, | 4% Boric Acid | 1663 | 998 | 60% |
| 10% Wood | | | | |
| extract | | | | |
| 20% Stafor ®, | 4% Boric Acid | 1945 | 856 | 44% |
| 10% Fructose | | | | |
| 20% Stafor ®, | 4% Boric Acid | 1700 | 578 | 34% |
| 6% PVOH | | | | |
| 4% Boric Acid | None | 3963 | 277 | 7% |

The control board treated with only boric acid retained about 7% of the initial impregnated boron after 14 weeks of accelerated weathering test. Boards treated with only the potassium salt of fumarized rosin, Stafor® L-50, retained about 19% of the initial boron. When the 1^{st} treating formulation contained a chelating component, in addition to the potassium salt of fumarized rosin, Stafor® L-50, the treated wood showed a significant increase in boron retention. Wood extract from spent kraft pulping liquor generally contains organic acids, lignin, hemicellulose, terpenes, natural wax, sodium salts, and several other minor organic ingredients. When wood extract was used as a chelating component, the boron retention increased to about 60%. When fructose and polyvinylalcohol (PVOH) were used as chelating component, the boron retention after 14 weeks of accelerated weathering test increased to about 44% and 34%, respectively.

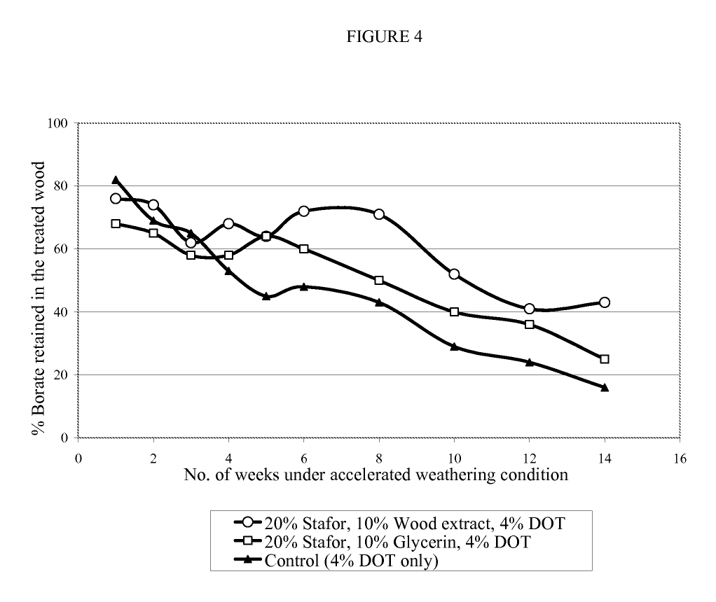

In some embodiments, boards were treated in a one-step process with a preservation formulation containing a boron-containing component such as DOT and a resinous component, optionally with a chelating component. (Table 4, FIG. 4)

TABLE 4

| | Amount of Boron in the Board | | |
|---|---|---|---|
| | | 14-week | % Retention |
| | Initial | weathering | after 14-week |
| Treating Formulation | (ppm) | (ppm) | weathering |
| 20% Stafor ®, | 3861 | 1660 | 43% |
| 10% Wood extract, 4% DOT | | | |
| 20% Stafor ®, | 3696 | 924 | 25% |
| 10% Glycerin, 4% DOT | | | |
| 4% DOT | 4100 | 656 | 16% |

The control board treated with only boric acid retained about 16% of the initial impregnated boron after 14 weeks of accelerated weathering testing. When the preservative formulation containing a potassium salt of fumarized rosin, wood extract chelating agent and DOT was used, the treated wood retained about 43% of the initial boron. When glycerin was used as a chelating component, the boron retention of the treated wood was about 25%.

One embodiment of the present invention comprises the steps of:

(i) immersing wood in a borate preservative formulation, wherein the non-volatile content of the formulation comprises:
(a) at least one boron-containing compound; and
(b) at least one resinous component comprising at least one member selected from the group consisting of rosin, rosin derivatives, tall oil-based compounds, and mixtures thereof,

(ii) loading the immersed wood with the formulation under excess pressure for a period of time sufficient to impregnate the wood with a biocidally effective level of borate, thereafter relieving the excess pressure; and

(iii) removing the wood from the liquid.

One embodiment of the present invention comprises the steps of:

(i) immersing wood in a liquid containing at least one borate-containing component;

(ii) loading the immersed wood with the liquid under excess pressure for a period of time sufficient to impregnate the wood with a biocidally effective level of borate, thereafter relieving the excess pressure;

(iii) removing the wood from the liquid;

(iv) drying the wood;

(v) loading the resulting wood with a liquid containing a resinous component, wherein the resinous component comprises at least one member selected from the group consisting of rosin, rosin derivatives, tall oil-based compounds, and mixtures thereof, and

(iv) removing the wood from the liquid.

One embodiment of the present invention comprises the steps of:

(i) immersing wood in a liquid containing a resinous component, wherein the resinous component comprises at least one member selected from the group consisting of rosin, rosin derivatives, tall oil-based compounds, and mixtures thereof;

(ii) loading the immersed wood with the liquid containing a resinous component;

(iii) removing the wood from the liquid;

(iv) drying the wood;

(v) loading the resulting wood with a liquid containing at least one borate-containing component under excess pressure for a period of time sufficient to impregnate the wood with a biocidally effective level of borate, thereafter relieving the excess pressure; and

(vi) removing the wood from the liquid.

The upper limit of the applicable pressure in steps (ii) and (v) mainly depends on the respective crushing strength of the wood, as collapsing of the wood should be avoided. In one embodiment, the applied pressure was in the range of about 50 psi to about 200 psi. Where desired, a vacuum may be applied during steps (ii) and (v) to support the efficiency of the loading.

Pesticidal wood treatments currently in use, such as CCA and ACQ, impart a color to the wood due to the nature of the metal ions present. This color also serves as a convenient indication for the consumer that the wood has been so treated. Where desired, at least one dye and/or pigment may be added to the borate preservative formulation of the present invention in order to impart a color to the resulting wood to serve as a similar indicator. A combination of lignin and a green pigment such as chlorinated copper phthalocyanine is particularly effective in mimicking the color of CCA-treated wood. The use of light-fugitive dyes may be particularly advantageous in this application; as the use of such dyes permits the wood to be colored for identification but, once the wood is in place in or on an outdoor structure, the exposure to sunlight will bleach the dye and the wood will revert to its natural color.

The following examples are provided to further illustrate the present invention and are not to be construed as limiting the invention in any manner.

### Experimental

One-Step Treatment Process:

Fourteen-inch mature southern pine sapwood boards were placed inside a treating container and immersed completely in a liquid containing 3200 g of a treating formulation. The treating container was placed inside an eight-inch diameter treater vessel. After the vessel was sealed, a vacuum of 22 inches of Hg was applied inside the vessel for 10 minutes. Then, the vessel was filled with air and pressurized to 150 psig. The pressure was held for 20 minutes before being released. The boards were removed from the treating container, and the container was emptied of solution. After drying with a paper towel, the treated boards were placed back in the treating container, which was then transferred back inside the vessel. Once the vessel was sealed, a vacuum of 25 inches of Hg was drawn for 10 minutes. After releasing the vacuum, the treated boards were removed from the pan and air dried for a minimum of one week.

Two-Step Treatment Process:

(a) Pressure Treatment with Primary Treatment Solutions

Fourteen-inch mature southern pine sapwood boards were placed inside a treating container and immersed completely in a liquid containing 3200 g of the first treating formulation. The treating container was placed inside an eight-inch diameter treater vessel. After the vessel was sealed, a vacuum of 22 inches of Hg was applied inside the vessel for 10 minutes. Then, the vessel was filled with air and pressurized to 150 psig. The pressure was held for 20 minutes before being released. The boards were removed from the treating container, and the container was emptied of solution. After drying with a paper towel, the treated boards were placed back in the treating container, which was then transferred back inside the vessel. Once the vessel was sealed, a vacuum of 25 inches of Hg was drawn for 10 minutes. After releasing the vacuum, the treated boards were removed from the pan and air dried for a minimum of one week.

(b) Pressure Treatment with Secondary Treatment Solutions

The boards previously treated with the primary solution were in placed inside a treating container and immersed completely in a liquid containing 3200 g of the 2^{nd} treating solution. The treating container was placed inside an eight-inch diameter treater vessel, and the same treating cycle as for the primary treatment process was applied to the treater vessel. After the treatment, the treated boards were removed from the vessel and air dried for a minimum of one week.

Accelerated Weathering of the Treated Board:

After one-week of drying, the treated boards were attached by screws to a deck frame, and the initial level of boron impregnated in the treated boards was determined using an ICP device. The deck was then placed under a simulated condition of 90 inches of rain using a 24 hour-cycle water spray consisting of 3 hours of water spray, 3 hours of drying, 3 hours of water spray, and 15 hours of drying. The treated boards were sampled weekly during the first six weeks and then every the other week from week 8 to week 14.

What is claimed is:

1. Treated wood comprising wood and borate preservative, wherein the borate preservative comprises:
(a) at least one boron compound, and
(b) at least one resinous component comprising at least one member selected from the group consisting of rosin, rosin derivatives, tall oil-based compounds, and mixtures thereof.

2. The treated wood of claim 1, wherein the non-volatile component of the borate preservative comprises:
(a) from about 10% to about 90% by weight of at least one boron compound; and
(b) from about 10% to about 90% by weight of a resinous component comprising at least one member selected from the group consisting of rosin, rosin derivatives, and mixtures thereof.

3. The treated wood of claim 1, wherein the non-volatile component of the borate preservative comprises:
(a) from about 30% to about 70% by weight of at least one boron compound; and
(b) from about 30% to about 70% by weight of a resinous component comprising at least one member selected from the group consisting of rosin, rosin derivatives, and mixtures thereof.

4. The treated wood of claim 1, wherein the boron-containing component comprises at least one member selected from the group consisting of boric acid, borate salts, borate esters, and mixtures thereof.

5. The treated wood of claim 1, wherein the rosin comprises at least one member selected from the group consisting of tall oil rosin, gum rosin, wood rosin, and mixtures thereof.

6. The treated wood of claim 1, wherein the rosin derivative comprises at least one member selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and mixtures thereof.

7. The treated wood of claim 1, wherein the tall oil-based compound comprises at least one member selected from the group consisting of tall oil pitch, crude tall oil, tall oil fatty acids, derivatives of tall oil fatty acids, and mixtures thereof.

8. The treated wood of claim 7, wherein the derivative of tall oil fatty acid comprises at least one member selected from the group consisting of esters, salts, dimer acids, trimer acids, triglycerides, amides, adducts of acrylic acids, adducts of unsaturated fatty acids, adducts of acrylic acids and unsaturated fatty acids, and mixtures thereof.

9. The treated wood of claim 1, wherein the resinous component comprises:
(a) from about 20% to about 100% by weight of the resinous component of at least one member selected from the group consisting of rosins, rosin derivatives, and mixtures thereof; and
(b) up to about 80% by weight of the resinous component of at least one non-rosin containing resinous material.

10. The treated wood of claim 9, wherein the non-rosin containing resinous material comprises at least one member selected from the group consisting of fatty acids, dimer acids, triglycerides, terpenes, phenolic resins, hydrocarbon resins, phenolic-modified terpene resins, phenolic-modified hydrocarbon resins, tall oil pitch, adducts of acrylic acids, adducts of unsaturated fatty acids, adducts of acrylic acids and unsaturated fatty acids, and mixtures thereof.

11. The treated wood of claim 1, wherein the preservative formulation is an emulsion, a dispersion, or a solution.

12. The treated wood of claim 1, wherein the preservative further comprises at least one component capable of chelating with boron to fix the boron in the treated wood.

13. The treated wood of claim 12, wherein the boron chelating component comprises at least one member selected from the group consisting of lignin-based compounds, alcohol-based compounds, proteins, wood extracts, and mixtures thereof.

14. The treated wood of claim 1, wherein the preservative further comprises at least one member selected from the group consisting of dyes, pigments, and mixtures thereof.

15. The treated wood of claim 1, wherein the wood comprises at least one member selected from the group consisting of structural lumbers, decking, fencing, facia boards, plywood, laminated lumber, chipboard, strandboard, construction elements for outdoor furniture, and construction elements for playground equipment.

16. The treated wood of claim 1, wherein the wood is for exterior application.

17. The treated wood of claim 1, wherein the wood is for above ground application.

18. The treated wood of claim 1, wherein the application of the preservative to the wood comprises at least one member selected from the group consisting of pressure treating, vacuum impregnating, soaking, spraying, painting, brushing, washing, dipping, rubbing, mixing, blending, infusion and combination thereof.

19. Treated wood obtained from the process comprising the steps of:
(i) immersing wood in a borate preservative formulation, wherein the non-volatile content of the preservative formulation comprises:
(a) at least one boron-containing compound; and
(b) at least one resinous component comprising at least one member selected from the group consisting of rosin, rosin derivatives, tall oil-based compounds, and mixtures thereof;
(ii) loading the immersed wood with the formulation under excess pressure for a period of time sufficient to impregnate the wood with a biocidally effective level of borate, thereafter relieving the excess pressure; and
(iii) removing the wood from the liquid.

20. The treated wood of claim 19, wherein the preservative formulation is an emulsion, a dispersion, or a solution.

21. The treated wood of claim 19, wherein a vacuum is applied during step (ii).

22. The treated wood of claim 19, wherein a pressure in the range of about 50 psi to about 200 psi is applied in step (ii).

23. Treated wood obtained from the process comprising the steps of:
(i) immersing wood in a liquid containing at least one borate-containing component;
(ii) loading the immersed wood with the liquid under excess pressure for a period of time sufficient to impregnate the wood with a biocidally effective level of borate, thereafter relieving the excess pressure;
(iii) removing the wood from the liquid;
(iv) drying the wood;
(v) loading the resulting wood with a liquid containing a resinous component, wherein the resinous component comprises at least one member selected from the group consisting of rosin, rosin derivatives, tall oil-based compounds, and mixtures thereof; and
(vi) removing the wood from the liquid.

24. The treated wood of claim 23, wherein the preservative formulation is an emulsion, a dispersion, or a solution.

25. The treated wood of claim 23, wherein a vacuum is applied during steps (ii) and/or (v).

26. The treated wood of claim 23, wherein a pressure in the range of about 50 psi to about 200 psi is applied in steps (ii) and/or (v).

27. Treated wood obtained from the process comprising the steps of:
(i) immersing wood in a liquid containing a resinous component, wherein the resinous component comprises at least one member selected from the group consisting of rosin, rosin derivatives, tall oil-based compounds, and mixtures thereof;
(ii) loading the immersed wood with the liquid containing a resinous component;
(iii) removing the wood from the liquid containing a resinous component;
(iv) drying the wood;
(v) loading the resulting wood with a liquid containing at least one borate-containing component under excess pressure for a period of time sufficient to impregnate the wood with a biocidally effective level of borate, thereafter relieving the excess pressure; and
(vi) removing the wood from the liquid.

28. The treated wood of claim 27, wherein the preservative formulation is an emulsion, a dispersion, or a solution.

29. The treated wood of claim 27, wherein a vacuum is applied during steps (ii) and/or (v).

30. The treated wood of claim 27, wherein a pressure in the range of about 50 psi to about 200 psi is applied in steps (ii) and/or (v).
